(19) United States
(12) Patent Application Publication
(10) Pub. No.: US 2012/0308178 A1
(43) Pub. Date: Dec. 6, 2012

(54) OPTICAL PATH SWITCHING DEVICE

(75) Inventors: MING-LEE CHU, HSIN CHU (TW); HSI-LIN CHANG, HSIN CHU (TW)

(73) Assignee: RADIANTECH, INC., HSIN CHU (TW)

(21) Appl. No.: 13/152,366

(22) Filed: Jun. 3, 2011

(51) Int. Cl. G02B 6/36

(52) U.S. Cl. 385/16

(57) ABSTRACT

An optical path switching device comprises at least one movable carrier plate; at least two optical fiber connection sockets arranged on the movable carrier plate and each connected with an optical fiber; and a driving device mechanical coupled to the movable carrier plate, driving the movable carrier plate to carry one of the optical fiber connection sockets to a position corresponding to an optical fiber connection plug, whereby the optical fiber connection plug can be coupled to the optical fiber connection socket connecting with an intended optical path. The present invention switches the optical path in a purely-mechanical way without using any optical component. The present invention has advantages of simple structure, low cost and low signal loss.

### BACKGROUND OF THE INVENTION

1. Field of the Invention

The present invention relates to an optical path switching device for optical-fiber communication, particularly to a purely-mechanical optical path switching device free of optical components.

2. Description of the Related Art

Optical fiber features high bandwidth, high communication capacity, low decay, long transmission distance, low crosstalk, high communication quality, anti-EMI, high security, and compactness. Therefore, optical-fiber communication using light and optical fiber has gradually replaced the conventional copper cable-based communication.

Optical fiber communication has been the mainstream communication method nowadays. An optical-fiber communication system usually comprises an emitter converting electric signal into optical signal; optical fiber transmitting the optical signal and normally buried under the ground to interconnect different buildings; a plurality of optical amplifiers to guarantee that the optical signal does not attenuate or distort; and an optical receiver receiving the optical signal and converting the optical signal into electric signal. An optical-fiber communication system also has a plurality of optical path switching devices performing two-way or multi-way optical path switching. Refer to FIG. 1. An optical path switching device can connect with or disconnect from an optical path to switch the transmission path of optical signal. An optical path switching device can also transmit light selectively, change light direction, and regulate light power.

The optical path switching devices may be categorized into the mechanical type and the waveguide type. The mechanical type optical path switching device mechanically controls the movements of prisms, mirrors, or lenses to switch the optical path of optical signal. The waveguide type optical path switching device utilizes the electro-optical, magneto-optical or acousto-optical effect to switch the optical path, i.e. utilizes directional coupling to control the input voltage and electrodes to vary the refractivity of the coupling material or induce polarization to change the optical path. No matter what type the optical path switching device is, it always needs precisely-aligned optical components. Therefore, the conventional optical path switching devices need precision and complicated structure and high-precision fabrication technology to guarantee accuracy of light refraction. Thus, the cost thereof is relatively higher.

Accordingly, the present invention proposes a purely-mechanical optical path switching device to overcome the abovementioned conventional problems.

### SUMMARY OF THE INVENTION

The primary objective of the present invention to provide a simple-structure and low-cost optical path switching device, which needn't use any optical components but switches the optical path in a purely-mechanical way.

Another objective of the present invention to provide an optical path switching device, which adopts optical fiber connection sockets and plugs, whose technology has been sophisticated, together with a mechanical mechanism to switch the optical path, whereby is reduced signal loss and promoted device reliability.

To achieve the abovementioned objectives, the present invention proposes an optical path switching device, which comprises at least one movable carrier plate; at least two optical fiber connection sockets each connecting with an optical path; an optical fiber connection plug connecting with an optical signal source and able to connect with one of the optical fiber connection socket; and a driving device driving the movable carrier plate to carry one optical fiber connection socket on the carrier plate to a position corresponding to the optical fiber connection plug, whereby the optical fiber connection socket cab be coupled to the optical fiber connection plug.

After an optical path is determined, the driving device drives the movable carrier plate to carry the optical fiber connection socket of the selected optical path to a position corresponding to the optical fiber connection plug, whereby the optical fiber connection socket can be coupled to the optical fiber connection plug. Thereby, the present invention can use a mechanical mechanism to switch the optical path.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a conventional optical path switching device;

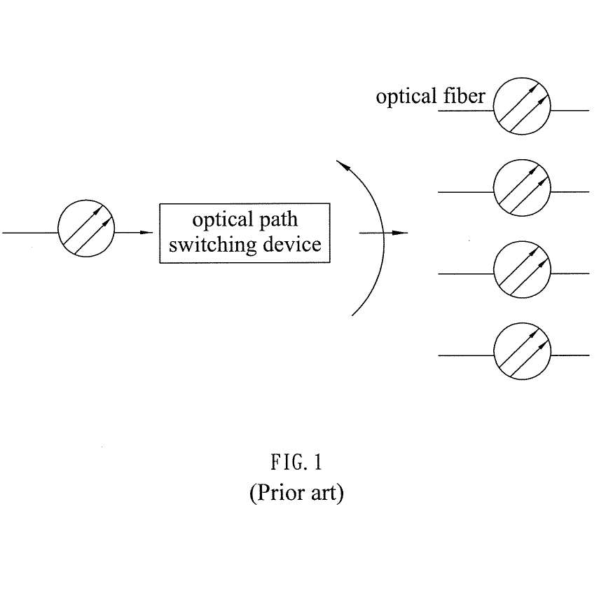

FIG. 2 is a front view schematically showing an optical path switching device according to one embodiment of the present invention;

FIG. 3 is a side view schematically showing an optical path switching device according to one embodiment of the present invention;

FIG. 4 is a top view schematically showing an optical path switching device according to one embodiment of the present invention;

FIG. 5 is a top view schematically showing that an optical fiber connection plug has been coupled to an optical fiber connection socket according to one embodiment of the present invention;

FIG. 6 is a diagram schematically showing an optical path switching device according to another embodiment of the present invention.

### DETAILED DESCRIPTION OF THE INVENTION

The technology of existing optical fiber connection sockets has been very sophisticated. The present invention uses the optical fiber connection sockets and a mechanical mechanism to switch the optical path. The optical fiber switching device of the present invention can be extensively applied to optical fiber communication systems. For example, the present invention can be applied to an optical time-domain reflector (OTDR) for detecting signal loss in an optical path and monitoring optical signal transmission. The present invention is also applied to protection or backup of optical fiber transmission.

In the present invention, the movable carrier plate may have various forms to meet the practical demand and the available space. For example, the movable carrier plate may be a rotatable disc or a linear-movement carrier plate able to move horizontally or vertically. Below, a rotatable disc is used to exemplify the movable carrier plate and demonstrate the present invention.

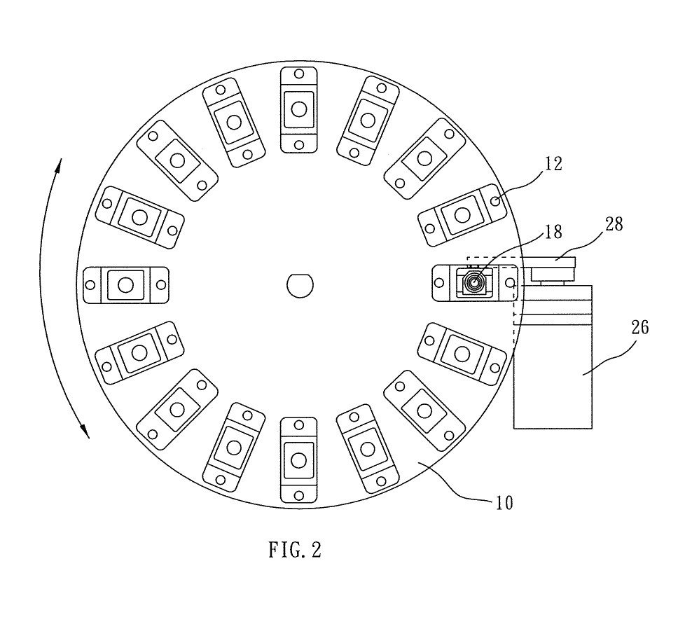

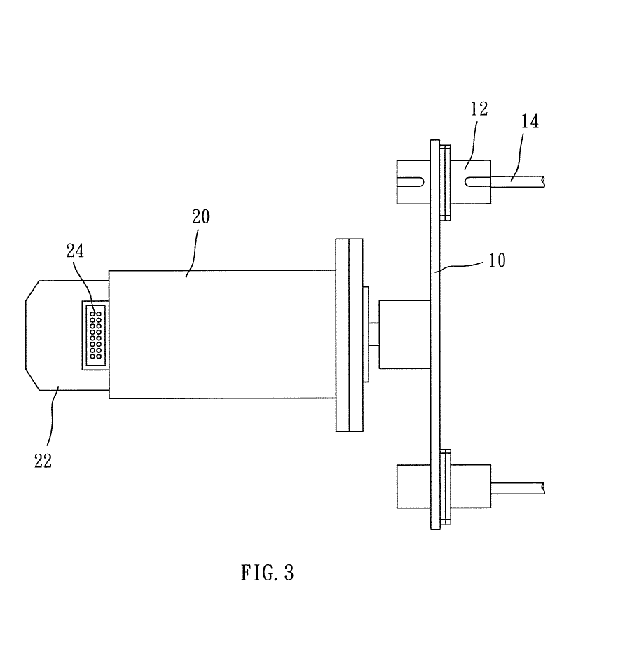

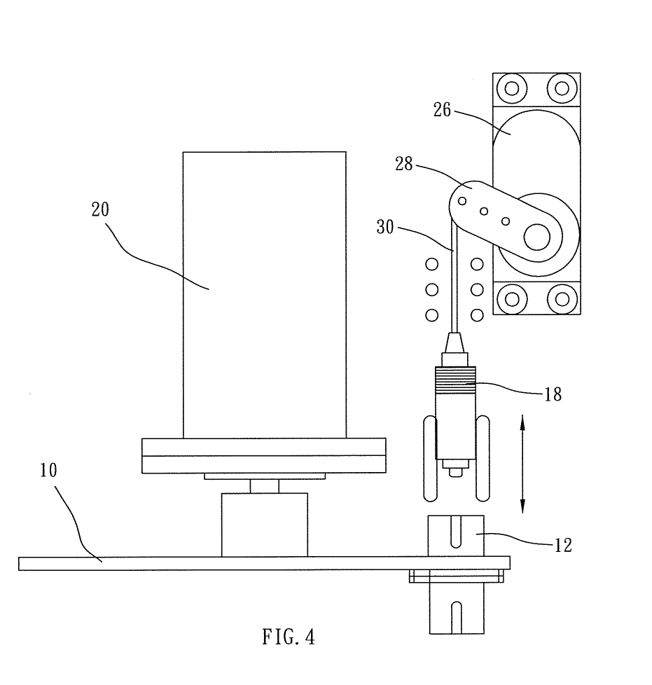

Refer to FIG. 2 and FIG. 3. The optical path switching device of the present invention comprises at least one movable carrier plate 10; at least two optical fiber connection sockets 12 uniformly arranged in the movable carrier plate 10, wherein the output terminal of each optical fiber connection socket 12 connects with an optical fiber 14 to form an optical path; an optical fiber connection plug 18 arranged beside the movable carrier plate 10 and able to connect with one of the optical fiber connection sockets 12, wherein the input terminal of the optical fiber connection plug 18 connects with an optical signal source (not shown in the drawings) via an optical fiber; and a driving device 20 driving the movable carrier plate 10 to carry one of the optical fiber connection sockets 12 to a position corresponding to the optical fiber connection plug 18, whereby the optical fiber connection socket 12 can be coupled to the optical fiber connection plug 18. In the embodiment shown in FIG. 3 and FIG. 4, the movable carrier plate 10 is a rotatable disc; there are sixteen optical fiber connection sockets 12 and thus sixteen optical paths. The driving device 20 is preferred to be a servo motor. In this embodiment, as the movable carrier plate 10 is a rotatable disc and as there are optical fibers 14 connecting with the optical fiber connection socket 12, the driving device 20 can only control the movable carrier plate 10 to rotate to and fro within an appropriate range, for example, to rotate within the range of ±180 degrees.

A control device 22 is arranged beside the movable carrier plate 10 and electrically connected with the driving device 20 for controlling the driving device 20. The control device 22 has a control panel 24 where the operator selects the optical path, whereby the driving device 20 is controlled to drive the movable carrier plate 10 to rotate and carry the optical fiber connection socket 12 of the selected optical path to a position corresponding to the optical fiber connection plug 10. Refer to FIG. 4. A servo device 26 is arranged beside the optical fiber connection plug 18 to enable the optical fiber connection plug 18 to smooth connect with the optical fiber connection socket 12. The servo device 26 has a rocking arm 28 controlling the optical fiber connection plug 18 to move to and fro. The rocking arm 28 uses a link 30 to couple with the optical fiber connection plug 18, whereby the servo device 26 can drive the optical fiber connection plug 18 forward to engage with or disengage from the optical fiber connection socket 12.

In one embodiment, the optical fiber connection socket 12 is a snap-fit connection socket, and the optical fiber connection plug 18 is a snap-fit connection plug.

The structure of the optical path switching device has been described above, and the switching process thereof will be described in detail below.

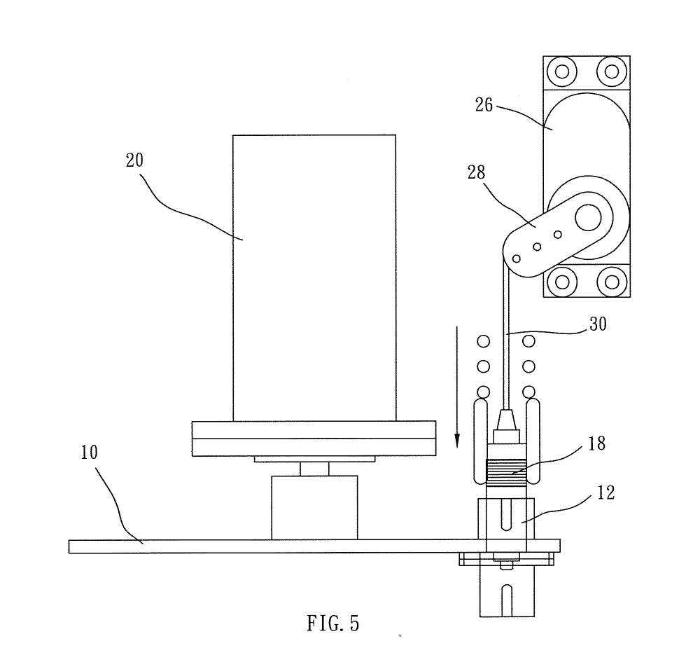

Refer to FIG. 2, FIG. 3 and FIG. 4. Firstly, the operator uses the control panel 24 of the control device 22 to select an optical path. Next, the control device 20 controls the driving device 20 to drive the movable carrier plate 10 to rotate with the maximum rotation range thereof being ±180 degrees. While the optical fiber connection socket 12 of the selected optical path is rotated to a position corresponding to the optical fiber connection plug 18, the movable carrier plate 10 stops rotating. Next, the servo device 26 actuates the rocking arm 28 to drive the link 30 to move the optical fiber connection plug 18 forward, whereby the optical fiber connection plug 18 is engaged with the optical fiber connection socket 12, as shown in FIG. 5. Thereby are transmitted optical signals. After transmission of optical signals is completed, the servo device 26 actuates the rocking arm 28 to drive the link 30 to move the optical fiber connection plug 18 backward, whereby the optical fiber connection plug 18 is disengaged from the optical fiber connection socket 12 and restored to the original position. Via repeating the abovementioned process, the optical fiber switching device of the present invention can switch the optical fiber communication system to different optical paths.

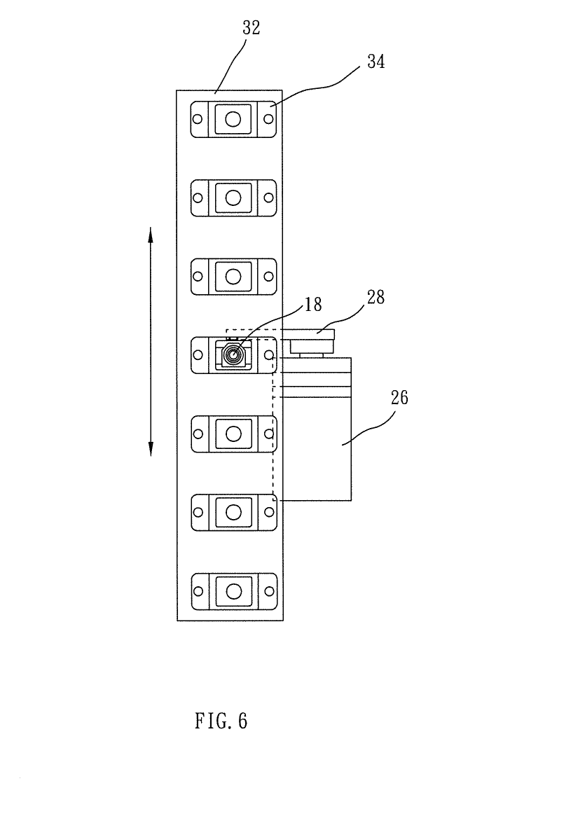

In the abovementioned embodiment, the movable carrier plate 10 is in form of a rotatable disc and rotated to switch the optical path. In another embodiment, the movable carrier plate 10 is moved linearly in a vertical or horizontal direction to change the optical fiber connection socket 12 engaged with the optical fiber connection plug 18. Refer to FIG. 6. In one embodiment, the movable carrier plate is in form of a rectangular movable plate 32, and a plurality of optical fiber connection sockets 34 is arranged on the rectangular movable carrier plate 32. In the switching process, the driving device 20 drives the movable carrier plate 32 to move left-and-right or up-and-down to switch the optical path. Except the form and movement of the movable carrier plate, the structure and operation of this embodiment are similar to those of the embodiment described hereinbefore and will not repeat herein.

In conclusion, the present invention switches the optical path in a purely-mechanical way without using any optical component. Therefore, the present invention operates precisely and reliably and has advantages of simple structure and low cost. The present invention utilizes optical fiber connection sockets and plugs, whose technology has been mature, together with a mechanical mechanism to switch the optical path. Therefore, the present invention has lower signal loss and higher reliability.

The embodiments described above are to demonstrate the technical thought and characteristics of the present invention and enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. An optical path switching device comprising:
at least one movable carrier plate;
at least two optical fiber connection sockets arranged on said movable carrier plate and each connected with an optical fiber, wherein one of said optical fiber connection sockets can be coupled to an optical fiber connection plug; and
a driving device driving said movable carrier plate to carry one of said optical fiber connection sockets to a position corresponding to said optical fiber connection plug, whereby said optical fiber connection plug can be coupled to said optical fiber connection socket.

2. The optical path switching device according to claim 1, wherein said movable carrier plate is a rotatable disc, and wherein said driving device drives said rotatable disc to rotate and change said optical fiber connection socket coupled to said optical fiber connection plug.

3. The optical path switching device according to claim 2, wherein said rotatable disc rotates to and fro.

4. The optical path switching device according to claim 1, wherein said driving device drives said movable carrier plate to move linearly in a vertical or horizontal direction to change said optical fiber connection socket coupled to said optical fiber connection plug.

5. The optical path switching device according to claim 1, wherein said driving device is a servo motor.

6. The optical path switching device according to claim 1, wherein said optical fiber connection plug is a snap-fit plug, and said optical fiber connection socket is a snap-fit socket.

7. The optical path switching device according to claim 1 further comprising a control device, which controls said driving device to actuate said movable carrier plate to select one said optical fiber connection socket that is connected with an intended optical path.

8. The optical path switching device according to claim 7, wherein said control device has a control panel, which is used to select an intended optical path, whereby said movable carrier plate is controlled to carry one said optical fiber connection socket connected with said intended optical path to a position corresponding to said optical fiber connection plug.

9. The optical path switching device according to claim 1, wherein said optical fiber connection plug is connected with an optical signal source via an optical fiber.

10. The optical path switching device according to claim 1 further comprising a servo device having a rocking arm, wherein said rocking arm uses a link to actuate said optical fiber connection plug to move forward and engage with said optical fiber connection socket or move backward and disengage from said optical fiber connection socket.
